(19) United States
(12) Patent Application Publication
(10) Pub. No.: US 2002/0173268 A1
(43) Pub. Date: Nov. 21, 2002

(54) External antenna for a wireless local loop system

(76) Inventor: Fred Judson Heinzmann, Los Altos, CA (US)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 09/899,927

(22) Filed: Jul. 9, 2001

Related U.S. Application Data
(60) Provisional application No. 60/290,682, filed on May 15, 2001.

(51) Int. Cl. H04H 1/00

(52) U.S. Cl. 455/3.05; 455/562

(57) ABSTRACT

A wireless local loop system is provided that includes a wireless base station that communicates with a subscriber station via a wireless link. The wireless link can carry a voice service, such as telephone calls, or a data service, such as internet browsing. The subscriber station is attached to an externally mounted steerable antenna. The antenna can be oriented in a desired direction during the transception of a voice or data service. A method of transceiving between a wireless local loop subscriber station and a wireless local loop base station is also provided.

### PRIORITY CLAIM

The present application claims priority from Applicant's copending application entitled “Wireless Local Loop Antenna” and filed in the United States Patent and Trademark Office on Feb. 5, 2001, and assigned application Ser. No. 09/775,510; and the Applicant's provisional patent application entitled “External Antenna for a Wireless Local Loop System” and filed in the United States Patent and Trademark Office on May 15, 2001. The contents of both these documents are incorporated herein by reference.

### FIELD OF THE INVENTION

The present invention relates to telecommunication systems, and more specifically, the present invention relates to a steerable subscriber station antenna for a wireless local loop system that is typically mounted on the exterior of the subscriber premises.

### BACKGROUND OF THE INVENTION

Various forms of modem wireless communications systems are well known. For example, cellular wireless voice services are now widely deployed in industrialized nations, and technology improvements are expected to enhance and expand cellular wireless services and lead to further deployment.

Wireless local loop (WLL) systems are expected to become a viable alternative to the wired local loop telephone services offered by the existing local telephone companies throughout North America. WLL systems typically include a network of wireless base stations, each serving a plurality of subscribers. In turn, each subscriber possesses a subscriber station that supports voice services (e.g. telephone) and/or data services (e.g. internet) using wireless communication with one or more of the base stations.

Attempts have been made to implement WLL systems. In general, these systems have either failed or not enjoyed broad penetration. One system that failed was the IONICA system implemented in United Kingdom. The IONICA system (explained in some detail in the Background of the Invention of U.S. Pat. No. 5,952,966 to Smith) required an antenna mounted to the exterior of the subscriber's premises and connected via a cable to the subscriber station within the subscriber premises. These external antennas needed to be installed by professional installers, often at significant expense, as the IONICA system required the subscriber antenna to be externally mounted and directed towards the base station best suited to service the subscriber.

Such external antennas suffered the additional problem that, as new subscribers and base stations were added, subscribers frequently needed to have their antenna readjusted by professional installers in order to redirect the subscriber's antenna to the new base station, thus increasing the expense of the system and causing frustration to the subscriber as they waited for the professional installer to make the adjustments. It has been suggested that IONICA failed, at least in part, because of the problems associated with unwieldy external antennas. In general, more modern WLL systems still rely on external antennas. For example, the so-called “Project Angel” system promulgated by AT&T uses an external antenna. While these more recent systems have overcome some of the other limitations of IONICA, the need for careful mounting of an external antenna can still be a barrier for some subscribers desiring access to WLL services.

Steerable antennas are also known. For example, U.S. Pat. No. 4,700,197 to Milne teaches an adaptive array antenna that is adapted for use in mobile terminals that communicate with satellite communication systems. One problem with Milne is that it directly contemplates satellite systems, thus Milne teaches away from the use of an adaptive array antenna in a terrestrial-based WLL system. In any event, Milne teaches the use of over a dozen parasitic elements that require complex controls to steer the antenna, and overall adding extra cost and/or complexity to the mobile terminal, thus making it generally unsuitable for use in a WLL system.

U.S. Pat. No. 6,037,905 to Koscica teaches a steerable antenna having a plurality of radiating elements that are comprised of a series of diodes connected in series with conductors having a length that is a fraction of the wavelength of the design frequency. A basic assumption behind Koscica is that the radiating elements (active or passive) are broken into lengths much smaller than a wavelength in order to make them electrically transparent. However, when this design is applied to common cellular telephone applications or a WLL system, the performance of this antenna would be poor because of the losses due to the plurality of diodes.

U.S. Pat. No. 6,034,638 to Thiel teaches a steerable antenna for use in mobile telephones. Thiel teaches an antenna having four equally spaced monopole elements mounted in a symmetric array on the outer surface of a solid cylinder structure. The cylinder has a high dielectric constant, and extends from a conductive ground plane. The monopole elements can be switched by switching elements so that one or more is active, with the others acting as parasitic directors/reflectors being connected to ground, or left in an open circuit to be effectively transparent. One problem with Thiel is that it is specifically directed to mobile cellular telecommunication systems, and thus teaches away from the application of a steerable antenna in WLL subscriber stations. Further, the mounting of the monopole elements within the solid cylinder structure results in an antenna that may be physically robust for the abuse to which a mobile telephone can be subjected, but is unnecessary and/or overly expensive when applied to a WLL subscriber station. Furthermore, Thiel teaches the switching of the elements in order to reduce the exposure of the subscriber to electromagnetic radiation when the cellular telephone is placed near the subscriber's head, a constraint that is not believed to be of concern in a WLL subscriber station. For example, Thiel teaches the switching of the driven elements, yet it is believed that switching in this manner can cause unacceptable performance loss in a WLL subscriber station. In general, the configuration of the antenna in Thiel and the method of switching the antenna in Thiel is directed to mobile applications, and is thus unsuitable for fixed wireless applications.

The above problems are mitigated or obviated, at least in part, by the antenna taught in Applicant's copending application entitled “Wireless Local Loop Antenna” and filed in the United States Patent and Trademark Office on Feb. 5, 2001, and assigned application Ser. No. 09/775,510 the contents of which are incorporated herein by reference, and from which the present application claims priority. “Wireless Local Loop Antenna” teaches, inter alia, an electrically steerable antenna that is integral with the subscriber station, making it suitable for indoor use. It has been determined that in certain situations, it can be desired to have additional transception quality than can be offered by an internal antenna. It is therefore desired to provide an antenna for a WLL system that provides improved transception-quality, while reducing the need for a professional installer of the antenna.

### SUMMARY OF THE INVENTION

It is an object of the present invention to provide a novel antenna for WILL systems that obviates or mitigates at least one of the above-identified disadvantages of the prior art.

In an aspect of the invention, there is provided a wireless local loop system for carrying at least one subscriber service between a network and a subscriber terminal via a wireless link. The system comprises at least one base station that interconnects the network and the wireless link. The base station is operable to transceive the subscriber service over the link. The subscriber station interconnects the subscriber terminal and the wireless link. The subscriber station is attached to an externally mounted steerable antenna that is operable to be oriented in a direction that achieves a desired transception-quality of the subscriber service over the wireless link.

The subscriber service is typically either a voice service (e.g. telephone calls) and/or a data service (e.g. web-browsing or email) but other types of services are within the scope of the invention. By the same token, the network is a network respective to the type of service, such as a public switched telephone network, private switched telephone network and/or a packet switched network.

The subscriber terminal can be any terminal operable to carry the subscriber service(s), such as telephone, computer, intelligent device, personal digital assistant or the like.

The antenna is typically electrically steerable and mounted on the exterior of the subscriber premises, and includes a plurality of directional antennas that are oriented in different sectors to each other. Each directional antenna is switchable such that the antenna transceives the radio link in a desired direction.

The tranception-quality can be measured using any suitable metric, such as signal-to-noise ratio, bit error rate, frame error rate, bit rate, power level and frame rate of the wireless link.

The desired transception-quality can be based on the orientation requiring the least emitted power level from the subscriber station.

A wireless local loop system is provided that includes a wireless base station that communicates with a subscriber station via a wireless link. The wireless link can carry a voice service, such as telephone calls, or a data service, such as internet browsing. The subscriber station includes a steerable antenna that can be mounted to the outside of the subscriber's premises, or any other location desirable to the subscriber. A presently preferred steerable antenna for use with the subscriber station includes a plurality of directional antenna elements each oriented in a different direction to the other.

The transception can be effected in a desired direction. By allowing the antenna to be dynamically steerable, the varying transception-qualities of the link, (caused by, for example, moving multipath objects) between the subscriber station and the base station can be compensated for in a dynamic fashion. It is believed the present invention can, in certain circumstances, obviate the need for the professional installation and manual orientation of a directional external, as the subscriber can mount the antenna himself or herself without being concerned whether the antenna is oriented in the proper direction. This also means that as additional base stations are added to the wireless local loop system, it is unnecessary to reorient the subscriber's antenna, thus saving additional cost and service interruptions of having a professional installer re-attend at the subscriber premises to reorient the antenna.

### BRIEF DESCRIPTION OF THE DRAWINGS

Preferred embodiments of the present invention will now be described, by way of example only, with reference to the attached Figures, wherein:

FIG. 1 shows a schematic representation of a wireless local loop system;

FIG. 2 shows a schematic representation of the base station in the system of FIG. 1;

FIG. 3 shows a schematic representation of one of the subscriber stations shown in the system of FIG. 1;

FIG. 4 shows a perspective view of the antenna in the subscriber station of FIG. 3;

FIG. 5 shows a front view of the antenna shown in FIG. 4;

FIG. 6 shows a top view of the antenna shown in FIG. 4;

FIG. 7 shows the top view of the antenna of FIG. 4 shown between the base station of FIG. 1 and a multipath object;

FIG. 8 shows flowchart showing a method for operating the antenna of FIG. 4;

FIG. 9 shows the antenna of FIG. 7 wherein a first of four of the sectors of the antenna is illuminated;

FIG. 10 shows the antenna of FIG. 7 wherein a second of four of the sectors of the antenna is illuminated;

FIG. 11 shows the antenna of FIG. 7 wherein a third of four of the sectors of the antenna is illuminated;

FIG. 12 shows the antenna of FIG. 7 wherein a fourth of four of the sectors of the antenna is illuminated; and,

FIG. 13 shows the antenna of FIG. 7 wherein two of the sectors are illuminated.

### DETAILED DESCRIPTION OF THE INVENTION

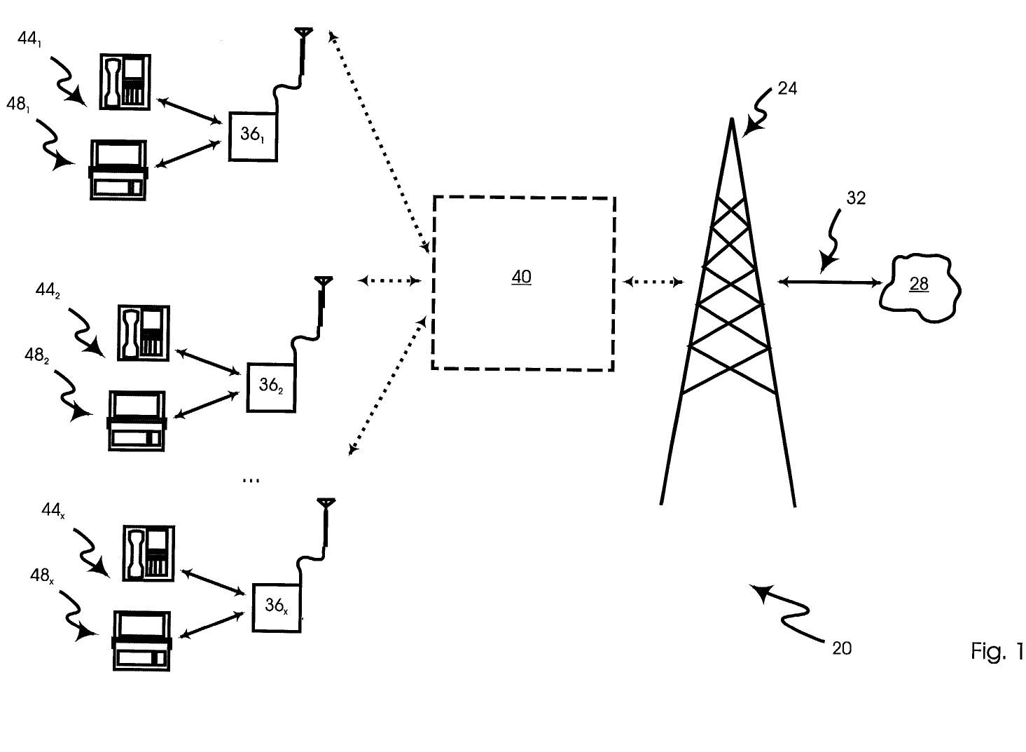

Referring now to FIG. 1, a wireless local loop system is indicated generally at 20. System 20 includes a wireless base station 24 that connects, through appropriate gateways (not shown), to a communication network 28 via a backhaul 32. Network 28 is typically the public switched telephone network (PSTN) combined with a packet switched data network, such as the Internet. Backhaul 32 can be any known type of backhaul link between wireless base station 24 and network 28, such as a T1, T3, OC1 or a wireless microwave link.

As will be explained in greater detail below, system 20 can have additional base stations 24, as desired, and that communications between multiple base stations 24 and subscriber stations 36 can be managed using known soft-handoff techniques. Additionally, base station 24 can be multi-sectored, each sector being defined by directional antennas, each sector comprising a different reception footprint.

A wireless link 40, composed of various communications channels, can be established between base station 24 and one or more of a plurality of subscriber stations 36. Utilizing one or more communication channels, wireless link 40 allows information to be transferred between base station 24 and respective subscriber stations 36, as needed. In a present embodiment, the radio-communication protocol employed over wireless link 40 is CDMA, however, other types of protocols, such as GSM, FDMA, OFDM, or TDMA are also within the scope of the invention. The implementation/type of packet communication employed is not particularly limited, and can include IP (with TCP or UDP) and/or modifications thereof or any other packet implementation as will occur to those of skill in the art. While the present embodiment is directed to digitally-based radio communications, it will be understood that the present invention can be modified to accommodate analog based radio communications, such as that found in analog cellular telephone networks.

In a presently preferred embodiment, each subscriber station 36 is fixed within a subscriber's premises. However, it is also contemplated that the present invention can be applicable, with appropriate modifications to mobile and/or nomadic subscriber stations. Each subscriber station 36 is operable to connect to a voice terminal 44 (e.g. a telephone) for conducting voice services, and to connect to a data terminal 48 (e.g. a computer) for conducting data services. It will thus be apparent that each voice terminal 44 and its respective data terminal 48 can be combined into a single intelligent device, such as a wireless telephone with a built-in web browser or any other intelligent device that is operable to process both voice and data. In general, each voice terminal 44 is operable to process voice telephone calls carried over the PSTN portion of network 28, while data terminal 48 is operable to process data applications carried over the packet switched data network portion of network 28. It is to be understood that in other embodiments of the invention, subscriber station 36 and system 20 can be modified to provide different types of services, or to only provide voice or data services.

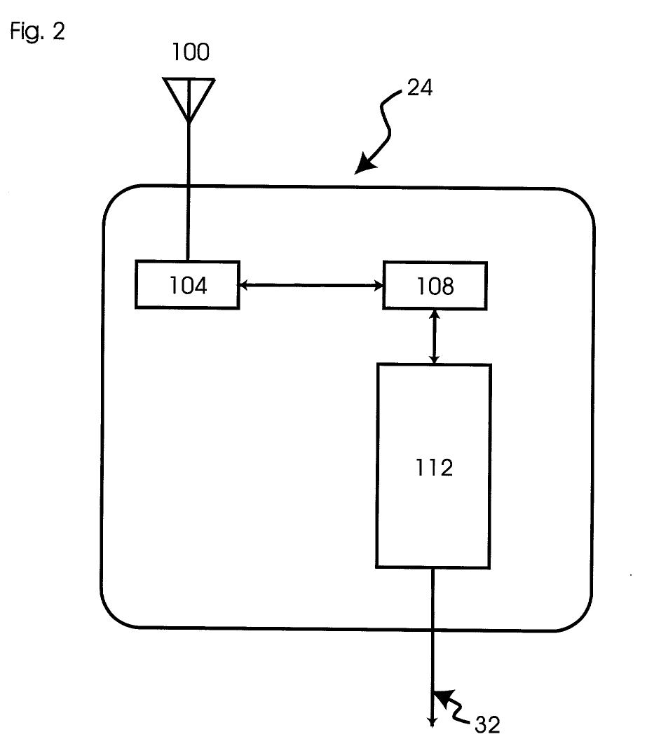

FIG. 2 shows base station 24 in greater detail. Base station 24 comprises an antenna 100 for receiving and transmitting radio-communications over wireless link 40. In turn, antenna 100 is connected, via any suitable connecting means, to a radio 104 and a modem 108. Modem 108 is connected to a microprocessor-router assembly 112. A suitable microprocessor would be a SPARC processor system manufactured by SUN Microsystems. It will be understood that assembly 112 can include multiple microprocessors, as desired. The router within microprocessor-router assembly 112 is connected to backhaul 32 in any suitable manner, which in turn connects base station 24 to network 28 via appropriate gateways (not shown). Other configurations of base station 24 will occur to those of skill in the art.

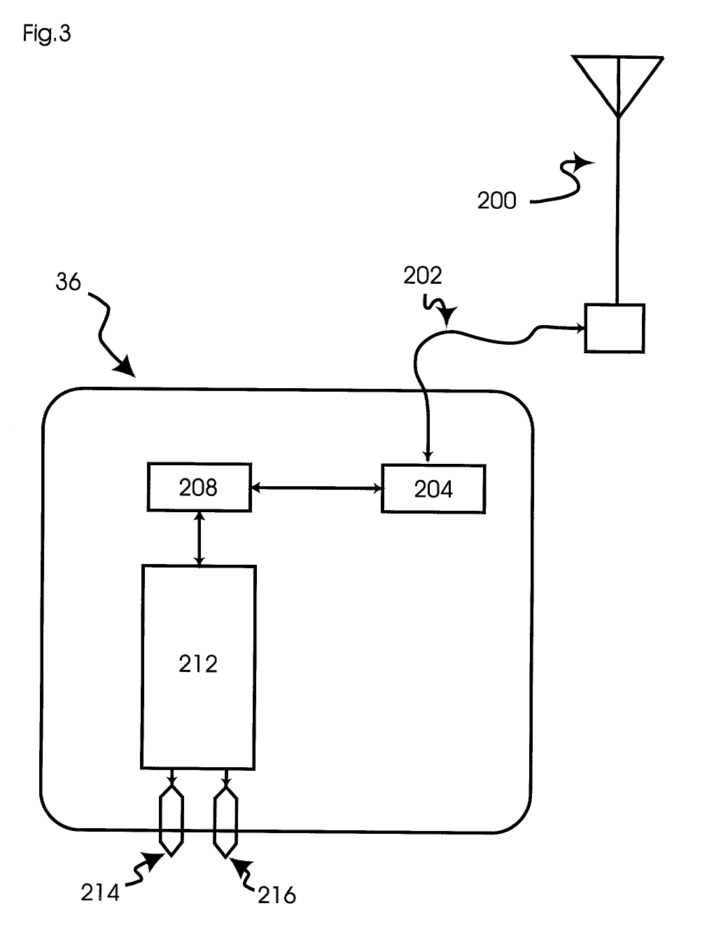

Referring now to FIG. 3, subscriber station 36 is shown in greater detail. Subscriber station 36 is attached to a steerable antenna 200 that is external to subscriber station 36, for receiving and/or transmitting (“transceiving”) radio-communications over wireless link 40. Station 36 and antenna 200 are connected via a wired-link 202, that carries power signals, control signals, and signals transceived over wireless link 40 between subscriber station 36 and antenna 200.

In turn, wired link 202 is connected to a radio 204 within subscriber station 36. Radio 204 then connects to a modem 208, which in turn is connected to a microprocessor-assembly 212. Typically, antenna 200 is mounted substantially vertical outside of the subscriber's premises, either directly to the premises or proximal thereto. While not shown herein, a protective radome, such as a plastic cylinder, is also typically included to protect antenna 200 from weather elements, while still allowing transception over wireless link 40. Antenna 200 is mounted any suitable mechanical hardware as will occur to those of skill in the art, although preferably as part of a kit mechanical hardware that would allow a subscriber to mount the antenna him or herself, without the need for a professional installer. While not a critical feature of the invention, in order to further simplify installation wired-link 202 is preferably a single piece of coaxial cable, such as that used in CATV installations. Thusly, subscriber station 36 and antenna 200 are designed such that power signals, control signals, and transceived signals over wireless link 40 are all carried over different frequencies within the CATV cable, with appropriate circuitry at each end to differentiate between each signal carried over link 202. However, it is also contemplated that wired-link 202 can include separate cables for each signal.

The remaining components of subscriber station 36 are housed within a chassis. For safety reasons, such a housing can be configured to restrict access by the subscriber to the components of subscriber station 36.

Microprocessor-assembly 212 which can include, for example, a StrongARM processor manufactured by Intel, performs a variety of functions, including implementing A/D-D/A conversion, voice codecs, filters, encoders, data compressors and/or decompressors for packet assembly/disassembly. As seen on FIG. 3, microprocessor-assembly 212 interconnects modem 208 and a pair of ports 214, 216. Accordingly, microprocessor-assembly 212 is operable to process voice services for voice terminal 44 (connected to port 214), and data services for data terminal 48 (connected to port 216).

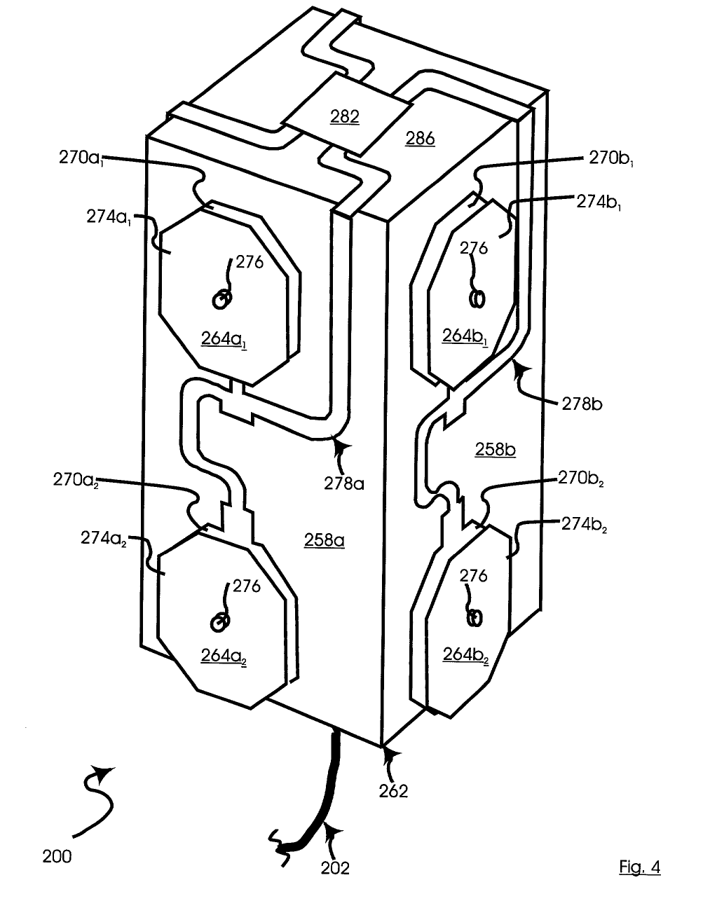

The type of external steerable antenna 200 used in association with subscriber station 36 is not particularly limited. However, a presently preferred steerable antenna 200 for use in subscriber station 36 is shown in FIGS. 4-6. Steerable antenna 200 comprises a plurality of elements 258a, 258b, 258c and 258d. In the presently preferred embodiment, antenna 200 is used within the spectrum of from about 1850 Megahertz (“MHz”) to about 1990 MHz (referred to herein as the “PCS band”). Each element 258 is sized and configured to be responsive within the PCS band. More particularly, the frequency range of from about 1850 MHz to about 1910 MHz is reserved for transmitting from subscriber station 36 to base station 24 (i.e. the “uplink” or “forward link”) over wireless link 40. Similarly, the frequency range from about 1930 MHz to about 1990 MHz is reserved for receiving transmissions from base station 24 to subscriber station 36 (i.e. the “downlink” or “reverse link”) over wireless link 40, with the remaining frequency range of about 1910 MHz to about 1930 MHz serving as a guard-band between the uplink and downlink. It is to be understood, however, that antenna 200 can be designed to operate in any frequency range, as desired.

In the present embodiment, each element 258 is effectively a directional antenna, oriented in different directions in relation to each other. Thus, each element 258 is oriented on antenna 200 at an angle of ninety degrees to the other, thereby providing four sectors of potential coverage, with at least the potential for additional coverage by using two or more elements 258 in combination. Thus, the base of each element 258 is defined by one of the four sides of a substantially square tubular substrate 262. Substrate 262 is preferably hollow, made from a thin gauge of aluminum that is rigid enough to support each element 258, yet light enough to reduce the overall weight of antenna 200 for considerations such as reduced materials cost, ease of assembly, ease of mounting, and/or ease of transport.

Each element 258 is characterized by a first sub-element 264₁ and a second sub-element 264₂. As shown in through FIGS. 4-6, elements 258a, 258b, 258c and 258d each have a first sub-element 264a₁, 264b₁, 264c₁, and 264d₁, respectively. By the same token, elements 258a, 258b, 258c and 258d also each have a second sub-element 264a₂, 264b₂, 264c₂ and 264d₂, respectively.

In turn, each sub-element 264 is characterized by an inner patch 270 and an outer patch 274. Each patch 270, 274 is substantially the same octagonal shape and of substantially the same size. A fastener-and-spacer assembly 276 is used to mechanically secure each inner patch 270 and outer patch 274 to substrate 262. As shown through FIGS. 4-6, first sub-elements 264a₁, 264b₁, 264c₁, and 264d₁ each have an inner patch 270a₁, 270b₁, 270c₁, and 270d₁, respectively, and an outer patch 274a₁, 274b₁, 274c₁, and 274d₁. By the same token, second sub-elements 264a₂, 264b₂, 264c₂ and 264d₂ each have an inner patch 270a₂, 270b₂, 270c₂, and 270d₂, respectively, and an outer patch 274a₂, 274b₂, 274c₂, and 274d₂.

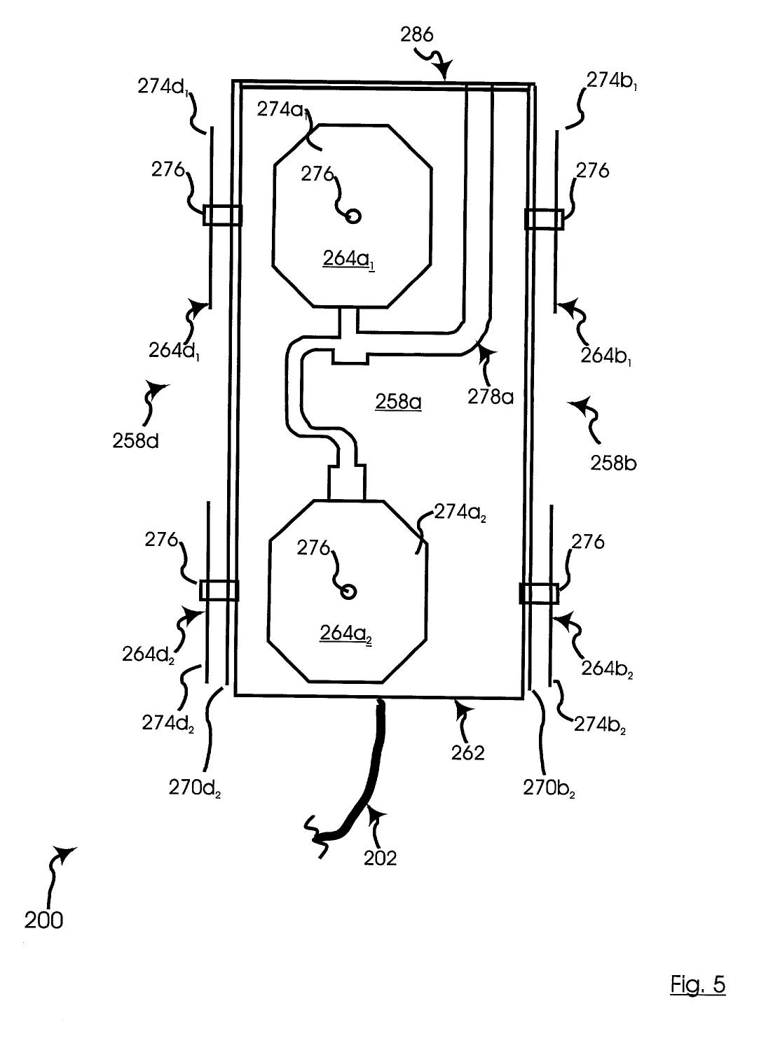

Each element 258 also includes a trace 278 that connects at one end to a switching means 282 resident on a cap portion 286 that closes tubular substrate 262. Each trace 278 runs along the surface of cap portion 286 to its periphery, at which point each trace 278 extends perpendicularly to cap portion 286 so that each trace 278 runs parallel to its respective element 258. As best seen in FIGS. 4 and 5, each trace 278 runs in an S-like shape along its respective element, interconnecting both inner patches 270 of the respective element 258 along the path of trace 258. Traces 278 and sub-elements 264 are all preferably made from aluminum, but any suitable conducting material for antennas can be used. Traces 278 and sub-elements 264 can be made from any suitable gauge of copper.

In the presently preferred embodiment, each trace 278 and the inner patches 270 that it interconnects are stamped or otherwise cut from a single piece of aluminum, thereby offering a simplified manufacturing process. The portion of trace 278 running parallel to cap portion 286 and the portion of each trace 278 running parallel to its respective element 258, and the junction thereof, are all impedance-matched to facilitate the manufacture of trace 278 from a single piece of aluminum and thereby help reduce the cost and/or complexity of antenna 200.

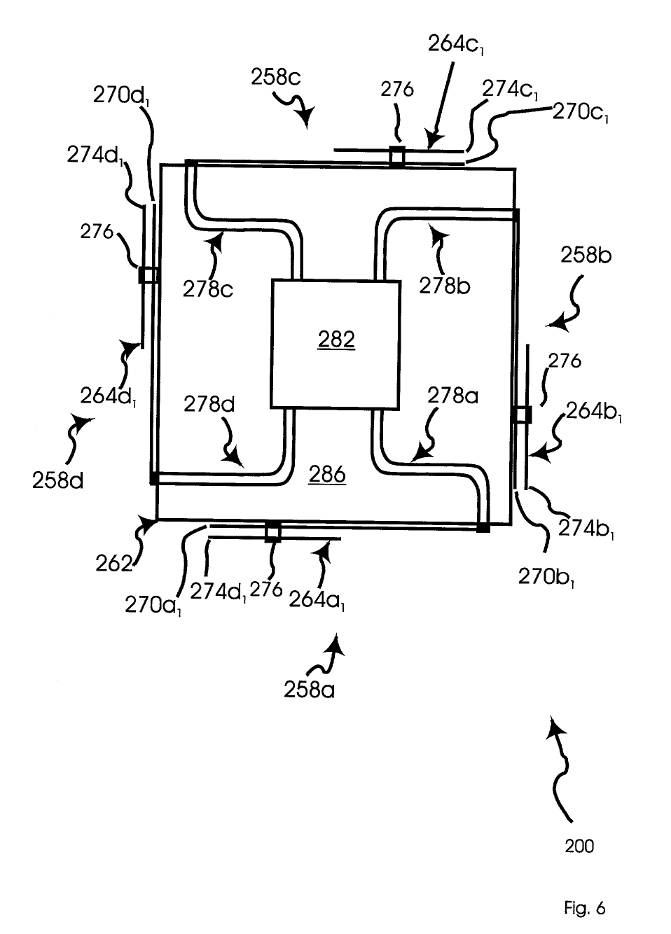

Referring now to FIGS. 4 and 6, switching means 282 interconnects each trace 278a, 278b, 278c, 278d. In a present embodiment, switching means 282 includes four PIN-diodes, where one PIN-diode is respective to each trace 278. Switching means 282 further includes a controller element that connects to wired link 202. (While not shown in the Figures, in the present embodiment wired link 202 enters through the hollow opening of tubular substrate 262 and passes through the interior of substrate 262 to terminate at switching means 282 on cap portion 286.) The controller element within switching means 282 is operable to extract a power signal 202 carried within wired-link 202, and a control signal carried within wired link 202. Furthermore, the controller element within switching means 282 is operable to activate the appropriate PIN diode, and thereby activate the corresponding element 258, according to the extracted control signal. Furthermore, the controller element within switching means 282 is operable to transmit signals received, over wireless link 40, by a given element 258 over wired link 202 to subscriber station 36, and to deliver signals received from subscriber station 36 to a given element 258 for transmission over wireless link 40.

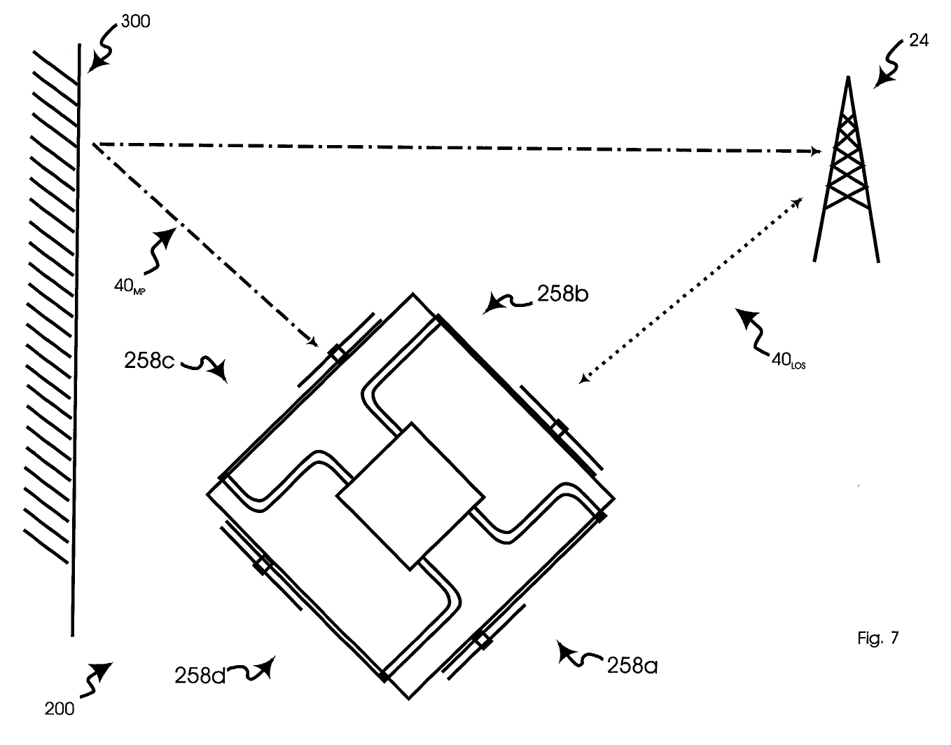

Referring to now to FIG. 7, antenna 200 is shown intermediate base station 24, and a multipath object 300. As seen in FIG. 7, base station 24 is transceiving wireless link 40. (As used herein, the term transceiving means transmitting and/or receiving.) However, in contrast to FIG. 1, due to multipath object 300 wireless wireless link 40 actually exists as two wireless links, 40_{LOS} and 40_{MP}. Thus, wireless link 40_{LOS} is a line-of-site instance of wireless link 40 between base station 24 and antenna 200, while wireless link 40_{MP} is a multipath instance of wireless link 40 between base station 24 and antenna 200. Multipath object 300 can be any object that causes multipath interference signals to exist between base station 24 and antenna 200, such as trees, rocks, buildings, walls and/or can be mobile objects such as trucks or other vehicles. Where multipath object 300 is mobile, it will be understood that wireless link 40_{MP} can change depending on the location of object 300. Additionally, it will be understood that FIG. 7 is a simplified example of links, 40_{LOS} and 40_{MP} and that more complex, and multiple multipath links 40_{MP} can exist between base station 24 and steerable antenna 200. Further—it will be also understood that subscriber station 36 can be positioned in relation to base station 24 such that no line-of-site link 40_{LOS} instance is available to subscriber station 36, and that in such cases only one or more multipath links 40_{MP} may be available to subscriber station 36. As will be explained in greater detail below, antenna 200 is operable to be oriented in a direction of having a desired transception-quality of a service over available links 40 such as the two links 40_{LOS} and 40_{MP} shown in FIG. 7.

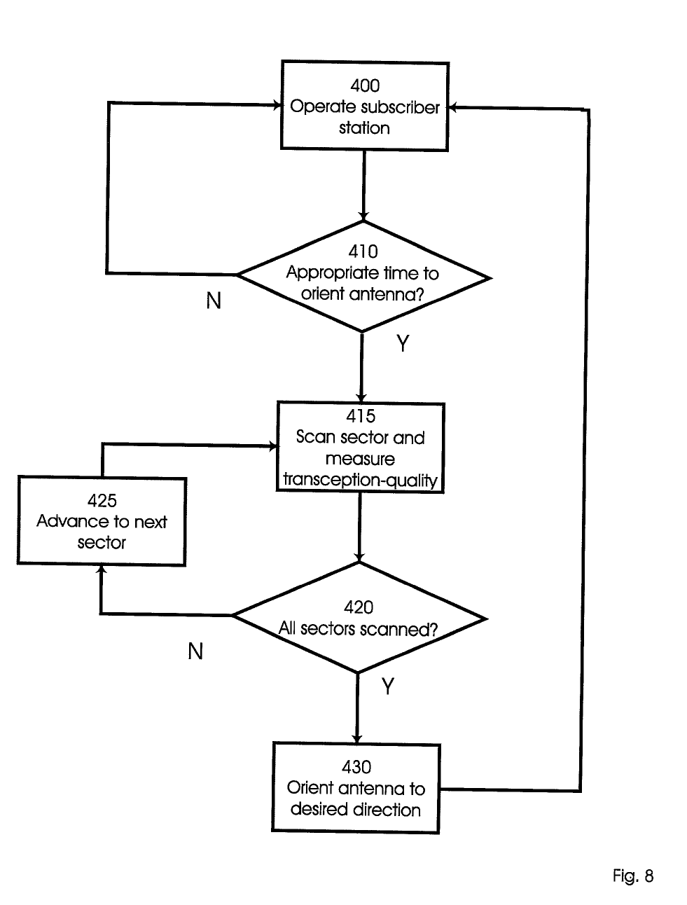

In accordance with another embodiment of the invention, a method for operating a steerable antenna in a WLL system will now be discussed with reference to the flowchart shown in FIG. 8. In order to assist in the explanation of the method, additional reference will be made to the foregoing FIGS. 1-7 and discussion of antenna 200. Beginning at step 400, subscriber station 36 is operated normally. Normal operation can include any number of states. For example, normal operation can be where subscriber station 36 is powered-on, and conducting an initialization sequence of loading operating system software and performing self-diagnostics, and preparing to attempt to establish communications with base station 24 over wireless link 40 using pilot channels or other signaling channels transmitted from base station 24 to subscriber station 36.

Another example of normal operation is where subscriber station 36 has already established communications with base station 24 over wireless link 40, subscriber station 36 may be carrying one or more voice telephone calls between voice terminal 44 and base station 24. Similarly, subscriber station 36 may be carrying one or more data services, (i.e. web-browsing, email) between data terminal 48 and base station 24.

Another example of normal operation is when subscriber station 36 has already established communications with base station 24 over wireless link 40, but be in an idle state where it is not carrying any service.

In the latter three examples of normal operation, it will be understood that antenna 200 will already be oriented in one particular direction towards base station 24. Other examples of normal operation of subscriber station 36 will occur to those of skill in the art.

The method then advances to step 410, where it is determined whether an appropriate time has been reached in which to orient (or reorient) antenna 200. This determination can be made based on any number of criteria, which would generally reflect the state of normal operation of subscriber station 36 at step 400 just prior to the advancement of the method to step 410. For example, where, at step 400, subscriber station 36 is attempting to establish initial communications with base station 24, then at a predetermined point during such initialization the determination at step 410 will typically determine that ‘yes’, now is an appropriate time to orient antenna 200, in order to allow subscriber station 36 to acquire a desired signal with base station 24.

In contrast, where, at step 400, subscriber station 36 is engaged in a voice telephone call using voice terminal 44, it is generally believed that this would be an inappropriate time to reorient the antenna from an existing orientation, due to the risk of dropping the voice call. (While presently less preferred, it is to be understood that there can be situations where it may be desired to reorient antenna 200 during a voice call.)

Where, at step 400, subscriber station 36 is carrying a data service between data terminal 48 and base station 24, then at step 410 it may be desired to reorient antenna 200 if the bit-rate (or other metric of transception-quality) has fallen below a certain threshold. For example, where subscriber station 36 has been able to achieve a higher bit-rate when carrying previous data services between data terminal 48 and base station 24, yet at the time the method reaches step 410 this bit-rate has dropped below that higher bit-rate, then it can be desired to reorient antenna 200 in an attempt to increase the bit-rate. It is believed during the processing of a data service can be an appropriate time in which to reorient antenna 200, due to the fact that many data services, such as web-browsing and email transfer are latency tolerant, and accordingly the service can be safely, and briefly, interrupted in order to attempt to achieve a higher bit-rate through antenna reorientation.

Similarly, where, at step 400, subscriber station 36 is in an idle state (i.e, where communications with base station 24 have been established and yet no service is active), then subscriber station 36 can, at predetermined time intervals, attempt to reorient itself in relation to wireless link 40 in an attempt to secure a more desirable signal with base station 24, especially where subscriber station 36 is aware of a drop in uplink or downlink bit-rate, signal-to-noise ratio, or other measurement of transception-quality with respect to wireless link 40.

Other criteria for determining, at step 410, whether an appropriate time for orienting (or reorienting) antenna 200 has been reached will occur to those of skill in the art and are within the scope of the invention.

Referring again to FIG. 8, where, at step 410 it is determined that it is not an appropriate time to orient (or reorient) antenna 200, then the method returns back to step 400 where normal operation of subscriber station 36 proceeds. However, if it is determined that an appropriate time has been reached to orient antenna 200, then the method advances to step 415.

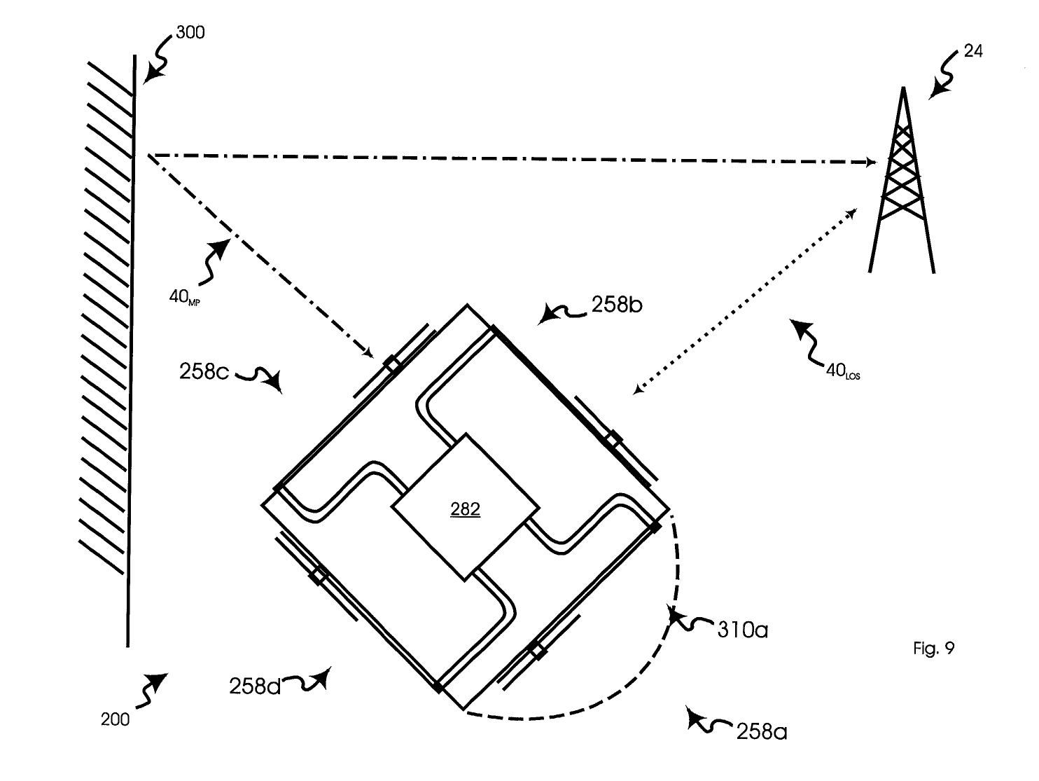

When the method first advances to step 415, an initial (perhaps arbitrarily chosen) sector in which antenna 200 can be directed is scanned and a measurement of transception-quality is taken. In order to explain this step and the subsequent steps, it is useful to explain the method in conjunction with examples shown in FIGS. 9-12. As indicated in FIG. 9, it is assumed that the first sector that is scanned is sector 310a, which corresponds to element 258a. According to the previously-described configuration of antenna 200, sector 310a is illuminated by sending a control signal along wired-link 202 to switching means 282 that switches the PIN diode corresponding to element 258a in the active state thereby capturing any signal entering sector 310a and/or transmitting any uplink signal from sector 310a. By the same token, the remaining elements 258b, 258c and 252d are switched into the inactive state, rendering them inactive.

Having illuminated sector 310a, the transception-quality of wireless link 40 in sector 310a is measured and stored for later use. Continuing with the example shown in FIG. 9, the measurement of tranception-quality in sector 310a is extremely poor, as neither wireless link 40_{LOS} or wireless link 40_{MP} is present in sector 310a.

Any metric for transception-quality can be used. For example, signal-to-noise ratio, emitted power level, bit error rate, frame error rate or combinations thereof in the uplink and/or the downlink of wireless link 40 can be used.

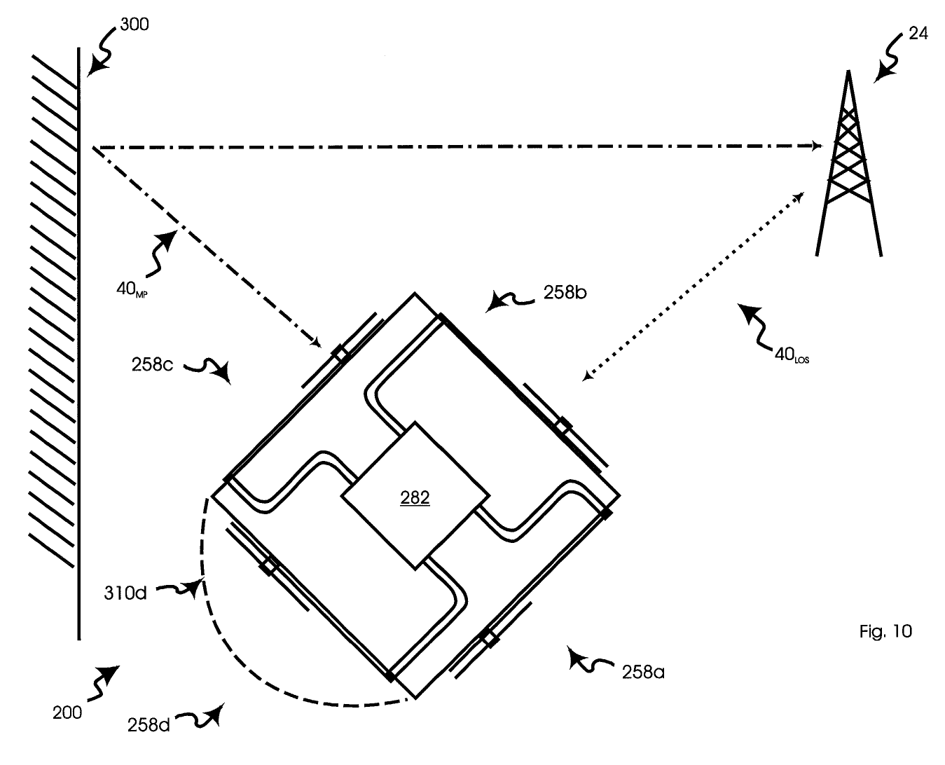

The method then advances to step 420, where it is determined whether all sectors have been scanned. Continuing with the present example, not all of the sectors of antenna 200 have been scanned, and the method moves to step 425 and antenna 200 is advanced to the next sector. This advancement is represented in FIG. 10, where sector 310d is now shown as being illuminated. The illumination of sector 310d is accomplished in a manner which will now be apparent to those of skill in the art, namely, sector 310d is illuminated by sending a control signal along wired-link 202 to switching means 282 that switches the PIN diode corresponding to element 258d in the active state thereby capturing any signal entering sector 310d and/or transmitting any uplink signal from sector 310d. By the same token, the remaining elements 258a, 258c and 252d are switched into the inactive state, rendering them inactive.

The method then returns to step 415, at which point the transception-quality of sector 310d is measured and stored for later use. Continuing with the example shown in FIG. 10, the measurement of tranception-quality in sector 310d is extremely poor, as neither wireless link 40_{LOS} or wireless link 40_{MP} is present in sector 310d.

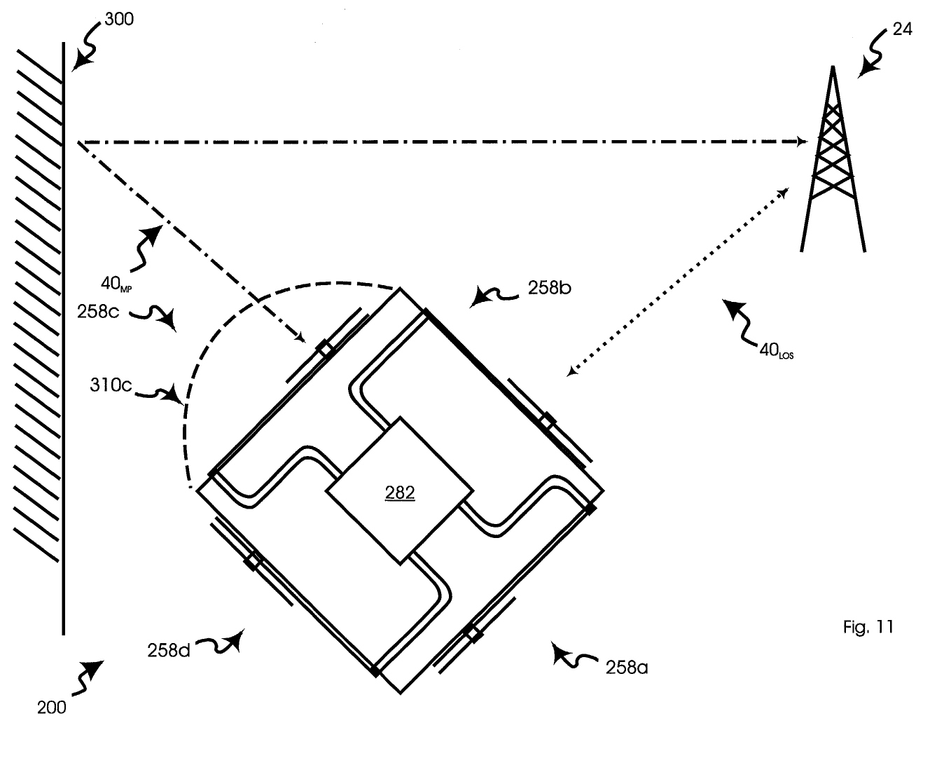

The method then advances again to step 420, where it is determined whether all sectors have been scanned. Continuing with the present example, two of the sectors of antenna 200 remain unscanned, and so method moves to step 425 and antenna 200 is advanced to the next sector. This advancement is represented in FIG. 11, where sector 310c is now shown as being illuminated. The illumination of sector 310c is accomplished in a manner which will now be apparent to those of skill in the art, namely, sector 310c is illuminated by sending a control signal along wired-link 202 to switching means 282 that switches the PIN diode corresponding to element 258c in the active state thereby capturing any signal entering sector 310c and/or transmitting any uplink signal from sector 310c. By the same token, the remaining elements 258a, 258b and 252d are switched into the inactive state, rendering them inactive.

The method then returns to step 415, at which point the transception-quality of sector 310c is measured and stored for later use. Continuing with the example shown in FIG. 11, the measurement of tranception-quality in sector 310c detects the presence of wireless link 40_{MP} in sector 310c. It is to be understood that while wireless link 40_{MP} is a multipath instance of wireless link 40, this fact is unknown to subscriber station 36, which simply takes a measurement of link 40_{MP} using the desired metric.

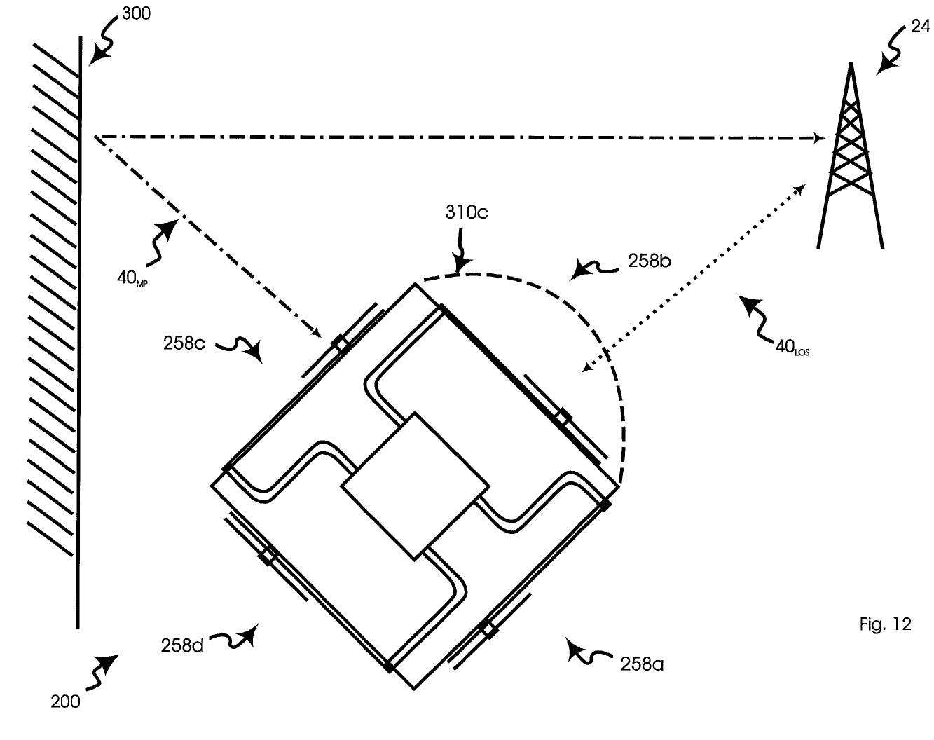

The method then returns again to step 420, where it is determined whether all sectors have been scanned. Continuing with the present example, one of the sectors of antenna 200 remains unscanned, and so method moves to step 425 and antenna 200 is advanced to the next sector. This advancement is represented in FIG. 12, where sector 310b is now shown as being illuminated. The illumination of sector 310b is accomplished in a manner which will now be apparent to those of skill in the art, namely, sector 310b is illuminated by sending a control signal along wired-link 202 to switching means 282 that switches the PIN diode corresponding to element 258b in the active state thereby capturing any signal entering sector 310b and/or transmitting any uplink signal from sector 310b. By the same token, the remaining elements 258a, 258c and 252d are switched into the inactive state, rendering them inactive.

The method returns once more to step 415, at which point the transception-quality of sector 310b is measured and stored for later use. Continuing with the example shown in FIG. 12, the measurement of tranception-quality in sector 310b detects the presence of wireless link 40_{LOS} in sector 310b. It is to be understood that while wireless link 40_{LOS} is a line-of-sight instance of wireless link 40, this fact is unknown to subscriber station 36, which simply takes a measurement of link 40_{MP} using the desired metric.

The method then returns again to step 420, where it is determined whether all sectors have been scanned. This time, it is determined that all sectors 310a, 310b, 310c and 310d have been scanned, and accordingly, the method advances to step 430.

At step 430, antenna 200 is oriented in a desired direction. This orientation is made using a selection criteria that considers the transception-quality measurements taken at step 415. The simplest selection criteria is to simply select the sector 310 with the best transception-quality, for example, where the transception-quality is measured in terms of signal-to-noise ratio (SNR), then the sector with the highest SNR will be chosen. According to the examples shown in FIGS. 9-12, it is generally expected that sector 310b, shown in FIG. 12, would have the highest SNR, as sector 310b captures a line-of-sight instance of wireless link 40 (i.e. wireless link 40_{LOS}).

However, any selection criteria can be used, and such criteria are expected to be more complex where there are additional multipath objects 300, no line-of-sight link exists, and/or where there are multiple base stations 24 and additional subscriber stations 36 all attempting to carry voice and/or data services. Those of skill in the art will now recognize that, in more complex situations, tranception-quality will vary between the uplink and downlink of wireless link 40. For example, in a CDMA system, one selection criteria for the uplink can be to choose whichever sector 310 (or, in other words, orientation) allows subscriber station 36 to operate at the lowest possible level of transmission power thereby reducing interference with adjacent subscriber stations 36. This criteria can be useful, for example, where subscriber station 36 is simply uploading data to base station 24 over wireless link 40, and not utilizing the downlink of wireless link 40, however, where both the downlink and uplink of wireless link 40 are being utilized, more complex selection criteria can be used to achieve desired operating functionality of system 20.

Having selected the desired sector 310 for antenna 200, the appropriate sector 310b is illuminated by sending a control signal along wired-link 202 to switching means 282 that switches the PIN diode corresponding to element 258b in the active state thereby capturing any signal entering sector 310b and/or transmitting any uplink signal from sector 310b. By the same token, the remaining elements 258a, 258c and 252d are switched into the inactive state, rendering them inactive. (I.e., in the present example shown in FIG. 12, sector 310b).

At this point, the method returns to step 400, where normal operation of subscriber station 36 resumes. The steps 400-430 thus continuously cycle to reorient antenna 200 in a direction that provides optimal and/or desired operation of subscriber station 36, or until wireless link 40 is broken, terminated by either subscriber station 36, base station 24 or some other multipath object 300 that causes wireless link 40 to break.

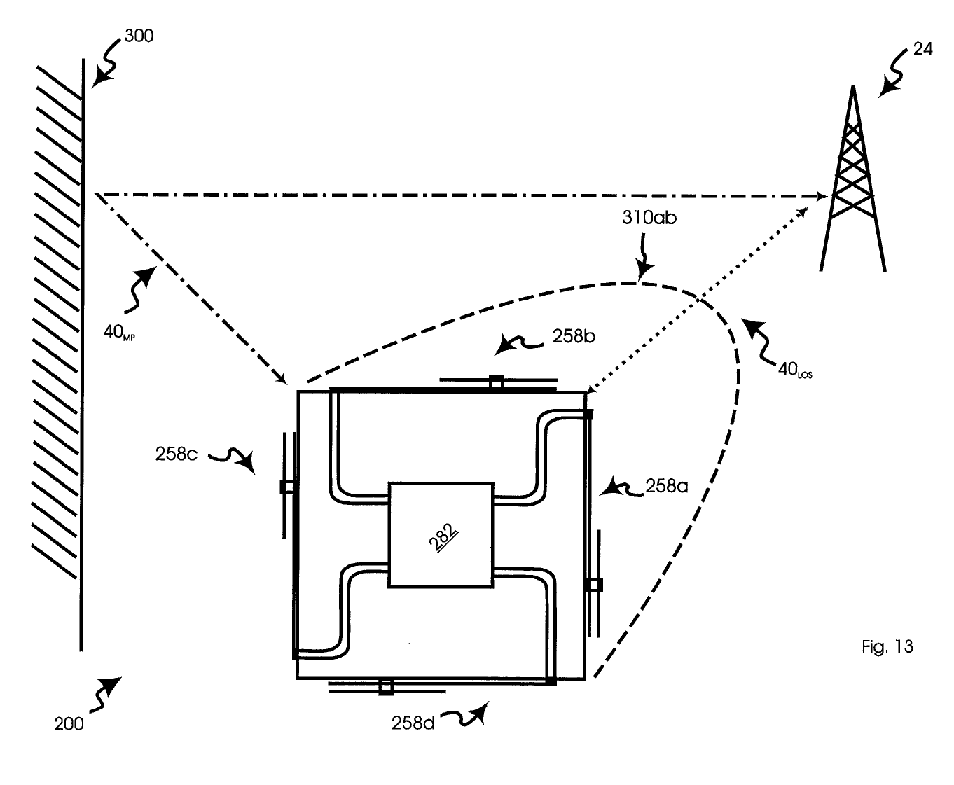

While the embodiments discussed herein are directed to specific implementations of the invention, it will be understood that combinations, sub-sets and variations of the embodiments are within the scope of the invention. For example, it is contemplated that the embodiments of FIGS. 4-6 can be varied so that one or more elements 258 can be activated simultaneously. This could be advantageous where wireless link 40 is incident with antenna 400 at a point in between two elements 258, in which case it can be desired to activate both adjacent elements 258 to capture wireless link 40. This situation is represented, by way of example, in FIG. 13, where a sector 310ab is shown as illuminated by activating element 258a and element 258b.

Additionally, while the embodiments shown in FIGS. 4-6 are directed to radio communications in the PCS band, it is to be understood that the embodiments discussed herein can be modified for use in other bandwidths, and such modifications are within the scope of the invention.

Additionally, while antenna 200 in the embodiments discussed herein each elements 258 is switched with a PIN diode, such switching may be accomplished in other ways, such as through the use of GaA FETs.

While the embodiments discussed above relate to a presently preferred external steerable antenna for use with a wireless local loop subscriber station 36, it is to be understood that other types of steerable antennas can be used in conjunction with wireless local loop subscriber station 36, and that such other types are within the scope of the invention. To name but one of several possibilities, a yagi-type antenna could be mounted to the exterior of a subscriber's premises, and automatically rotated using a servo motor.

It is also contemplated that the present invention can include multiple steerable antennas attached to subscriber station 36. For example, one steerable antenna can be used for transmitting on the uplink, whereas the other antenna can be used for receiving over the downlink, and whereby each antenna can be oriented in different directions according to desired transmission-quality for the uplink, and reception-quality for the downlink. Alternatively, utilizing a variation of the embodiments shown in FIGS. 4-6, one element 258 could be activated for the uplink, while the other activated for the downlink, in the event that different directions could prove to be optimum for each link. For example, this could occur in systems with multiple base stations, where one element 258 is oriented towards one base station 24, while another element is oriented towards another base station 24. In this case, tranception could be accomplished with the use of both base stations 24.

Furthermore, it is to be understood that where subscriber station 36 is within range of two or more base stations, then the present invention can be used to allow a subscriber station 36 to steer its antenna towards the most desirable signal available from one of those base stations. The foregoing aspect of the invention can be utilized with soft-handoff or other types of handoff techniques.

It is also contemplated that the present invention can be modified to provide a wireless local loop subscriber station with one or more steerable antennas that are steerable in multiple planes: for example, steerable in both horizontal planes and vertical planes, in order to allow the antenna to be directed in both the horizontal and vertical planes to achieve a desired transception-quality.

The configuration of each element 258 in the embodiments show FIGS. 4-6 may be described as a double-coupled patch antenna. It is to be underst. however, that each element 258 could be configured differently, depending on the desired characteristics of antenna 200. For example, in the present embodiment, each outer patch 274 serves as a parasitic element to its respective inner patch 270, thereby improving performance over entire the entire PCS band. It is to be understood, however, that the use of such a parasitic element is optional. Furthermore, the utilization of two sub-elements 264 in the vertical plane can narrow, in relation to the use of one sub-element 264, the elevation plane in which a particular element 258 operates. Accordingly additional or fewer sub-elements 264, in either the horizontal or vertical planes can be chosen to provide a desired aperture of each element 258. Furthermore, while the embodiment shown in FIGS. 4-6 has four elements 258, antenna 200 can have additional or fewer elements 258, as desired. It is also to be understood that other types of elements 258 can be used. For example, the embodiments discussed herein elements 258 are essentially four individual directional antennas, yet in other embodiments there could be a single active antenna element with a plurality of parasitic elements that could be switched in or out, to influence the radio signal in relation to the active element. An example of such an antenna is taught in the applicant's co-pending application Wireless Local Loop Antenna.

Furthermore, it is contemplated that the present invention could be offered as kit in addition to the wireless local loop subscriber station having an internal steerable antenna, as taught in, for example, Wireless Local Loop Antenna. In this case, additional circuitry would be provided within subscriber station 36 to accommodate the attachment of the external antenna 200 shown in FIGS. 4-6, allowing subscriber station 36 to switch between utilization of its own, internal antenna, or an external steerable antenna 200 of the like discussed herein.

While the discussion herein is primarily directed to fixed subscriber stations in wireless local loop systems, it will be understood that the present invention can also be applied to nomadic or mobile subscriber stations in more traditional wireless telephony and/or internet systems, by offering a means to attach such nomadic or mobile subscriber stations into an steerable external antenna, such as that taught in the exemplary embodiments hereabove.

The present invention provides a novel antenna for a wireless local loop system. The present invention provides a steerable antenna that adds spatial diversity to a radio link between a base station and a subscriber station in a wireless local loop. The antenna is external to subscriber station, but the steerable nature of the antenna can obviate or mitigate the requirement for professional installation, as required with prior art external antennas found in existing wireless local loop systems. Furthermore, the present invention obviates the need for professional remounting of the antenna when new base stations are added to the wireless local loop system, or where new structures arise that create unacceptable multipath interference. Additionally, since the direction of the antenna can be dynamically changed, the present invention allows for redirecting of the antenna according to changing system requirements. For example, where a first direction of the antenna affords superior bit rate transmission than a second direction that affords superior bit rate reception than the first direction, then the antenna can be changed between these two directions according to whether the subscriber stations is predominantly engaged in uplink transmission or downlink reception. Furthermore, where the use of an omnidirectional antenna can be placed in a location subject to destructive interference from multipath signals, the present invention allows the antenna to be reoriented so as to minimize the effects of the destructive interference. Furthermore, the use of two steerable antennas, one for transmission and one for reception, as taught in certain embodiments of the invention, can allow for each antenna to be oriented in different directions in order to achieve desired transmission-qualities and reception-qualities, respectively.

The above-described embodiments of the invention are intended to be examples of the present invention and alterations and modifications may be effected thereto, by those of skill in the art, without departing from the scope of the invention which is defined solely by the claims appended hereto.

We claim:

1. A wireless local loop system for carrying at least one subscriber service between a network and a subscriber terminal via a wireless link, said system comprising:
at least one base station interconnecting said network and said wireless link, said base station operable to transceive said service over said link; and
a subscriber station interconnecting said subscriber terminal and said wireless link, said subscriber station being connected to a steerable antenna that is mounted externally to said subscriber station and is operable to be oriented in a direction having a desired transception-quality of said service over said link.

2. The wireless local loop system of claim 1 wherein said subscriber service includes a voice service, said subscriber terminal is a voice terminal and said network includes the public switched telephone network.

3. The wireless local loop system of claim 1 wherein said subscriber service includes a data service, said subscriber terminal is a data terminal and said network includes the internet.

4. The wireless local loop system of claim 1 wherein said wireless link is based on CDMA.

5. The wireless local loop system of claim 1 wherein said steerable antenna is electrically steerable.

6. The wireless local loop system of claim 5 wherein said steerable antenna includes a plurality of directional antennas each defining a different sector of coverage for said antenna, each of said directional antennas being switchable in relation to each other such that said antenna transceives said radio link in said direction.

7. The wireless local loop system of claim 6 wherein said steerable antenna includes four of said directional antennas at an angle of ninety degrees to the other, and each of said directional antennas having a coupled patch configuration.

8. The wireless local loop system of claim 7 wherein said coupled patch configuration includes a plurality of sub-elements.

9. The wireless local loop system of claim 1 wherein said subscriber service is fixed within said subscriber's premises.

10. The wireless local system of claim 1 wherein said tranception-quality is measured using at least one of the metrics of signal-to-noise ratio, bit error rate, frame error rate, bit rate, power level and frame rate of said link.

11. The wireless local loop system of claim 1 wherein said desired transception-quality is based on an orientation of said antenna requiring a lowest emitted power level from said antenna.

12. The wireless local loop system of claim 6 wherein one of said directional antennas is selectively used for an uplink portion of said link and another of said directional antennas is selectively used for a downlink portion of said link, each of said directional antennas being selected according to a desired transmission-quality of said uplink and a desired reception-quality of said downlink.

13. The wireless local loop system of claim 1 wherein said subscriber station includes at least one steerable antenna orientable in both horizontal and vertical planes.

14. The wireless local loop system of claim 6 wherein each of said sub-elements includes a substantially octagonal outer-patch and a substantially octoganal inner-patch, said outer patch serving as a parasitic element to its said respective inner patch.

15. A method of orienting a steerable antenna connected to a wireless local loop subscriber station, comprising the steps of:
a. determining an appropriate time to orient said antenna;
b. illuminating said steerable antenna in a given orientation and measuring a transception-quality of a wireless link in said given orientation;
c. repeating said illuminating step until a desired number of orientations have been illuminated; and,
d. orienting said antenna towards the one said orientation that has a desired transception-quality for a subscriber service transmitted over said link.

16. The method according to claim 15 wherein each said orientation is a sector of a circle.

17. The method according to claim 15 wherein said desired number of orientations is the entire number of orientations in which said steerable antenna can be oriented.

18. The method according to claim 15 wherein said appropriate time is reached if said subscriber station is initializing communication over said wireless link between said subscriber station and a base station.

19. The method according to claim 15 wherein said appropriate time is determined based on a type of service being carried over said link.

20. The method according to claim 19 wherein said appropriate time is reached if said service is a data service that is latency tolerant.

21. The method according to claim 18 wherein said appropriate time is reached if said subscriber station is in an idle state.

22. The method according to claim 15 wherein said tranception-quality is measured with at least one of the metrics of signal-to-noise ratio, bit error rate, frame error rate, bit rate, power level and frame rate of said link.

23. The method according to claim 15 wherein said link is based on CDMA and said desired transception-quality is based on the one of said orientations requiring the least emitted power level from said subscriber station.

24. A subscriber station for a wireless local loop system that carries at least one subscriber service between a network and a subscriber terminal, said system including at least one base station interconnecting said network and a wireless link, said base station operable to transceive said service over said link, said subscriber station comprising:
a microprocessor-assembly interconnecting said subscriber terminal and a modem, said microprocessor-assembly for processing said subscriber service, said modem for modulating and demodulating said service,
a radio connected to said modem and for converting said service for tranception over said wireless link; and,
a connection means for attaching a steerable antenna to said radio, said steerable antenna operable to be oriented in a direction that achieves a desired transception-quality of said service over said link.

25. The subscriber station of claim 24 wherein said subscriber service includes a voice service, said subscriber terminal is a voice terminal and said network includes the public switched telephone network.

26. The subscriber station of claim 24 wherein said subscriber service includes a data service, said subscriber terminal is a data terminal and said network includes the internet.

27. The subscriber station of claim 24 wherein said wireless link is based on CDMA.

28. The subscriber station of claim 24 wherein said steerable antenna is electrically steerable.

29. An antenna for a wireless local loop subscriber station comprising:
a connecting means for attaching said antenna to a radio of said subscriber station;
a plurality of directional antennas each defining a different sector of coverage for said antenna, each of said directional antennas being switchable in relation to each other such that said antenna transceives a radio link in said direction.

30. The antenna of claim 29 wherein said steerable antenna includes four of said directional antennas at an angle of ninety degrees to the other, and each of said directional antennas having a coupled patch configuration.

31. The antenna of claim 30 wherein said coupled patch configuration includes a plurality of sub-elements.

32. The antenna of claim 29 wherein said desired transception-quality is based on an orientation of said antenna requiring a lowest emitted power level from said antenna.

33. The antenna of claim 30 wherein one of said directional antennas is selectively used for an uplink portion of said link and another of said directional antennas is selectively used for a downlink portion of said link, each of said directional antennas being selected according to a desired transmission-quality of said uplink and a desired reception-quality of said downlink.

34. The antenna of claim 30 wherein said subscriber station includes at least one steerable antenna orientable in both horizontal and vertical planes.

35. The antenna of claim 30 wherein said each of said sub-elements includes a substantially octagonal outer-patch and a substantially octoganal inner-patch, said outer patch serving as a parasitic element to its said respective inner patch.

36. The antenna according to claim 29 wherein said subscriber service includes a voice service and said subscriber terminal is a voice terminal.

37. The antenna according to claim 29 wherein said subscriber service includes a data service and said subscriber terminal is a data terminal.

38. The antenna according to claim 29 wherein said wireless link is based on CDMA.

39. A kit of parts for an antenna for a wireless local loop subscriber station, said kit comprising comprising:
an externally mountable steerable antenna portion;
a connecting means for interconnecting said antenna to a radio of said subscriber station;
mounting hardware complementary to said antenna portion for affixing said antenna portion to a structure; and,
a radome for protecting said antenna portion from weather.

40. The kit of parts according to claim 39 wherein said connecting means is wireless.

41. The kit of parts according to claim 39 wherein said connecting means is wired.

42. The kit of parts according to claim 41 wherein said connecting means is a single piece of coaxial cable for carrying controls signals, power signals and transceived signals over a radio link, said antenna portion and said subscriber station further include means for differentiating said signals.
